(19) United States
(12) Patent Application Publication
(10) Pub. No.: US 2008/0272627 A1
(43) Pub. Date: Nov. 6, 2008

(54) Adjustable enclosure for use on vehicles

(76) Inventor: Jacob Jurgen Joab, La Mesa, CA (US)

Correspondence Address: ERIC HANSCOM, 7395 PORTAGE WAY, CARLSBAD, CA, 92011, US

(21) Appl. No.: 12/111,966

(22) Filed: Apr. 30, 2008

Related U.S. Application Data
(60) Provisional application No. 60/927,297, filed on May 3, 2007.

(51) Int. Cl. B60J 7/047

(52) U.S. Cl. 296/220.01

(57) ABSTRACT

An adjustable enclosure for a vehicle is disclosed where the roof and rear portions of the enclosure can be moved to expose portions of the vehicle previously enclosed. The adjustable enclosure includes roof panels that can slide and collapse on top of each other to be conveniently stored above another part or inside of the vehicle. A truck bed can be enclosed with the current invention where the roof panels can be stored above the cab of a truck. The adjustable enclosure can also be used on a sport utility vehicle where the rear portion of the roof can collapse over the front portion. This adjustable enclosure enables the same vehicle to be used as both a fully enclosed vehicle, capable of comfortably transporting passengers or other items, and a partially open vehicle, capable of transporting oversized items or otherwise exposing the rear portion of the vehicle.

### CROSS REFERENCE TO RELATED APPLICATIONS

This application relates to and claims the benefit of U.S. Provisional Patent Application 60/927,297 filed on May 3, 2007, the entirety of which is herein incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of vehicle parts, and more specifically toward an adjustable enclosure for a vehicle where the roof and rear portions of the enclosure can be moved to expose portions of the vehicle previously enclosed. The adjustable enclosure includes roof panels that can slide and collapse on top of each other to be conveniently stored above another part or inside of the vehicle. A truck bed can be enclosed with the current invention where the roof panels can be stored above the cab of a truck. The adjustable enclosure can also be used on a sport utility vehicle where the rear portion of the roof can collapse over the front portion. This adjustable enclosure enables the same vehicle to be used as both a fully enclosed vehicle, capable of comfortably transporting passengers or other items, and a partially open vehicle, capable of transporting oversized items or otherwise exposing the rear portion of the vehicle.

Traditional truck bed shells, also known as covers or campers, are known in the art to provide protection and security for items left in the bed of a truck. They are attached to the rails, or sides, of a truck bed and can be locked to prevent theft of items left in the truck bed. However, these truck bed shells are a hindrance when trying to transport oversized items that will not fit beneath the cover of the truck bed shell. To move these large items, the truck bed shell must be removed from the truck. This can be a long and difficult process, where the entire truck bed shell must be detached and removed from the truck and then stored while it is not in use. In fact, garage systems have been designed to lift the truck bed shell off of the truck and store it suspended from the ceiling. Needless to say, these systems are often expensive and take up valuable space, especially when storing the truck bed shell separate from the truck.

Sport Utility Vehicles, or SUVs, are often built on the same chassis as a pickup-truck. However, instead of having a front cab and a separate bed with a truck bed shell, the sport utility vehicle has one large compartment for passenger seating and for transporting items. With a sport utility vehicle, it is nearly impossible to transport oversized items that do not fit inside of the sport utility vehicle. Some users are able to attach oversized items to the roof of the sport utility vehicle, but this can lead to unpredictable and dangerous results.

U.S. Pat. No. 4,332,265, to Baker, teaches a collapsible tent that creates a compartment above the bed of a truck. The flexible material used to cover the truck bed does not offer the security and durability of a hard truck bed shell. U.S. Pat. No. 6,942,279, to Hoover, is a portable, collapsible truck bed shell, but must be removed and stored separately when storing or transporting oversized items in the bed of a truck.

Other attempts have been made to create covers for truck beds that are easily removed and/or stored. U.S. Pat. No. 4,807,921, to Champie, III, et al., discloses a sliding cover assembly mounted to the walls of the bed of a truck. U.S. Pat. No. 5,330,246, to Bernardo, improved upon Champie to create a retractable slatted rolling truck bed cover mounted to the walls of the bed of a truck. U.S. Pat. No. 5,752,736, to Nodier, teaches a removable and collapsible truck bed cover secured to the rail of a truck bed. U.S. Pat. No. 6,799,787, to Angelos, teaches a similar invention to Nodier wherein the truck bed cover is sectioned into panels and slide to retract. U.S. Pat. No. 6,908,139, to Szieff, discloses a truck bed cover that stacks the segments of the truck bed cover when retracted. However, these references disclose truck bed covers that are at the height of the truck bed rails. This translates into limited cargo space available to the user when the truck bed cover is attached to the bed.

Thus there has existed a long-felt need for a truck bed cover or sport utility vehicle that provides for a cargo volume comparable to that of traditional truck bed shells that can also allow for the transportation of oversized goods. The roof portion of the cover should be easily removed and stored in the vehicle to enable users to quickly and efficiently convert the enclosed truck bed or rear portion of a sport utility vehicle to an open area capable of transporting large oversized items.

The current invention provides just such a solution by having an adjustable enclosure for a vehicle where the roof and rear portions of the enclosure can be moved to expose portions of the vehicle previously enclosed. The adjustable enclosure includes roof panels that can slide and collapse on top of each other to be conveniently stored above another part or inside of the vehicle. A truck bed can be enclosed with the current invention where the roof panels can be stored above the cab of a truck. The adjustable enclosure can also be used on a sport utility vehicle where the rear portion of the roof can collapse over the front portion. This adjustable enclosure enables the same vehicle to be used as both a fully enclosed vehicle, capable of comfortably transporting passengers or other items, and a partially open vehicle, capable of transporting oversized items or otherwise exposing the rear portion of the vehicle.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### SUMMARY OF THE INVENTION

The current invention is an improvement over prior art truck bed covers or enclosures and the rear portion of sport utility vehicles. It allows a user to place oversized items into the bed of a pickup-truck without removing the truck bed enclosure. A hatch, used to enclose the rear portion of the enclosure, tucks into the rear roof panel of the enclosure. Panels of the truck bed enclosure can collapse together and be stored over the cab of the pickup truck. The sport utility vehicle embodiment of the current invention allows a user to place oversized items into the back of the sport utility vehicle, or alternatively, give those riding in the rear of the sport utility vehicle an open air experience.

It is a principal object of the invention to provide a pickup truck bed adjustable enclosure or modified rear portion of a sport utility vehicle where the roof can retract and stack above the cab of a pickup truck or over the front portion of the sport utility vehicle, respectively.

It is another object of the invention to provide a means for transporting large, oversized items in a pickup truck having a truck bed enclosure by opening the roof of the enclosure without removing the enclosure from the bed of the truck.

It is an additional object of the invention to provide a means for transporting large, oversized items in a sport utility vehicle by opening the rear portion of the roof of the sport utility vehicle.

It is a final object of this invention to provide an adjustable enclosure for a vehicle where at least a portion of the roof can easily be retracted and stored on the vehicle thereby removing the necessity of storing the roof of the enclosure when not needed.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

Various different vehicles are used as examples throughout this application, including a pick-up truck and a sport utility vehicle. However, it is intended that many additional types of vehicles can benefit from the current invention, including cars, larger trucks, and busses. The use of a specific type of vehicle in the specification, abstract, or drawings is not meant to limit the scope of this application to that type of vehicle.

### BRIEF DESCRIPTION OF THE FIGURES

FIG. 1 is a side perspective view of an embodiment of the current invention integrated into a sport utility vehicle.

FIG. 2 is a side perspective view of another embodiment of the current invention attached to a pickup truck.

FIG. 3 is a side perspective view of an additional embodiment of the current invention attached to a pickup truck.

FIG. 4 is a side perspective view of a portion of the roof rack used to hold the roof panels while the roof of the enclosure is open.

### DETAILED DESCRIPTION OF THE FIGURES

Many aspects of the invention can be better understood with reference to the drawings below. The components in the drawings are not necessarily drawn to scale. Instead, emphasis is placed upon clearly illustrating the components of the present invention. Moreover, like reference numerals designate corresponding parts through the several views in the drawings.

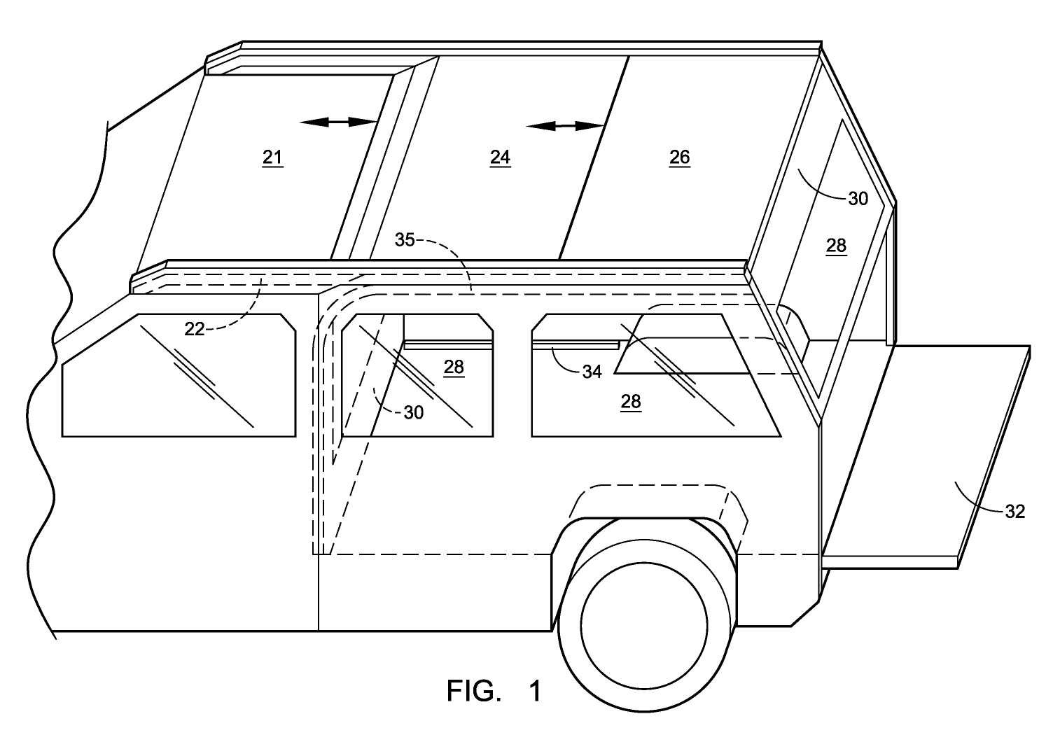

FIG. 1 is a side perspective view of an embodiment of the current invention integrated into a sport utility vehicle. In this figure, the current invention is integrated into a sport utility vehicle with a tailgate. It is an adjustable enclosure with a front roof panel 24, a rear roof panel 26, and a hatch 30.

To open up the adjustable enclosure such that the rear of the sport utility vehicle has no roof, a user will first unlock and open the tailgate 32 of the vehicle. Then, the user will lift the hatch 30, where the hatch is hinged to the adjustable enclosure at the top of the hatch 30. Once the hatch 30 is parallel to the opened tailgate 32, the user can slide the hatch 30 into the enclosure along a lower track 35. Sliders located at the top end of the hatch 30 allow it to initially slide along lower track 35 until the bottom portion of the hatch 30 meets the lower track 35. At this point, sliders located along the bottom portion of the hatch 30 engage the lower track such that the hatch glides along the track using the sliders located on the top and bottom edges of the hatch 30. As the hatch 30 is pushed along the lower track 35, the track 35 curves downward thereby allowing for the storage of the hatch 30 in a vertical position. Preferably, the lower track 35 curves downward behind the driver portion of the sport utility vehicle, such that the hatch 30 is stored in a vertical position behind the driver, as shown in this figure with dashed lines. This lower track 35 is similar to those often found in garage doors, where the panels travel along the track and change from a horizontal to a vertical orientation. The hatch 30, once at the end of the track 35, can be locked in place to prevent it from sliding along the track while the vehicle is moving. An alternative embodiment employs a panel and a hatch that drop into a vertical position. One of the solid roof panels tracks to the bed floor of the sport utility vehicle and doubles as a front bed-wall, similar to one found in a pickup truck. The hatch then tracks down on top of the solid roof panel thereby create a framed window, similar to a rear cab window found in a pickup truck.

As the user pushes hatch 30 along the lower track 35, the user will also push rear roof panel 26 along an upper track 22. In turn, the rear roof panel 26 pushes the front roof panel 24 along the upper track 22, where each roof panel shares the same upper track 22. The front roof panel 24 and rear roof panel 26 are pushed over the vehicle roof 21, where the front roof panel 24 travels along the upper track 22 until it reaches the forward limit, and the rear roof panel 26 travels along the upper track 22 until it reaches the forward limit, where the rear roof panel 26 is stacked directly above the front roof pane 24. Upper track 22 has, in the portion over vehicle roof 21, two parallel tracks such that both front roof panel 24 and rear roof panel 26 can spatially occupy positions above vehicle roof 21, in the fashion as a train can change tracks via a train track switch such that one train can park on a train track spur and allow another train to pass it by or park parallel to it on the adjacent track. Once both panels are at the end of the upper track 22, they can be locked in place to prevent them from sliding along the upper track 22 while the vehicle is moving.

The front roof panel 24, rear roof panel 26, and hatch are now secured in the open position, thereby providing an open area in the SUV for the storage and/or transportation of oversized items that could not otherwise have been easily transported in the vehicle. After the items have been secured in the vehicle, a track bar 34 can be slid into the upper track 22 and locked into place. The track bar 34 will help to secure the items within the vehicle as well as provide support and stabilize the rear pillars of the sport utility vehicle. A plurality of track bars 34 can also be used to help secure the load and/or provide support and stabilize the pillars of the vehicle. The tailgate 32 can then be closed or left open depending on the wishes of the user.

The side walls, hatch 30, or roof panels of the enclosure can be configured in many different ways. The side walls, hatch 30, or roof panels can be solid such that when the roof panels and hatch 30 are in the closed position, there are no windows to allow direct light into the enclosure, though some light may nonetheless enter from the windshield and/or driver and passenger seat windows. Alternatively, windows 28 can be configured into the side wall as well as the hatch 30 and/or roof panels. In this figure, the sidewalls and hatch 30 include windows 28.

It is also contemplated by the inventor that the roof panels can be secured at various points along the upper track 22, such that a smaller portion of the sport utility vehicle is open without a roof portion. The front roof panel 24 and rear roof panel 26 can also be stored in the open position while the hatch is stored in the closed position, thereby offering an enclosed area without a roof.

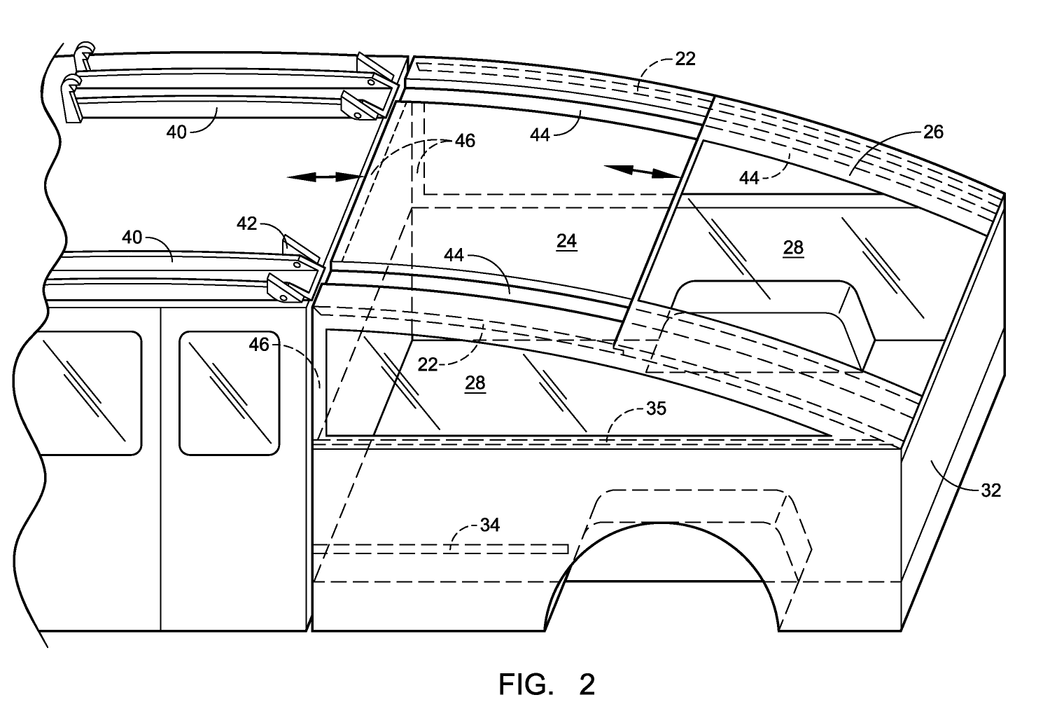

FIG. 2 is a side perspective view of another embodiment of the current invention attached to a pickup truck. In this embodiment, the enclosure is attached to a pickup truck with a tailgate where the enclosure is attached to the top rails of the pickup truck bed. It is an adjustable enclosure with a front roof panel 24, and a rear roof panel 26.

To open up the adjustable enclosure such that the bed of the pickup truck has no roof, a user will first unlock and open the tailgate 32 of the vehicle. The rear roof panel 26 and the front roof panel 24 each have channels 44, which are used to align the two panels as they are pushed together thereby creating stacked panels. The stacked panels are then pushed onto a roof rack 40, where the roof rack 40 is secured to the top of the cab of the pickup truck. Once the stacked panels are located on top of the roof rack 40, roof panel clamps 42 are rotated to an upright position and locked in place using a locking pin (not shown in this figure) thereby locking the stacked roof panels in place above the cab of the pickup truck.

The front roof panel 24 and rear roof panel 26 are now secured in the open position, thereby providing an open area in the pickup truck for the storage and/or transportation of oversized items that could not otherwise have been easily transported in the enclosed area of the vehicle. After the items have been secured in the vehicle, a track bar 34 can be slid into an upper track 22, which travels along the upper portion of the frame 46 of the enclosure, and locked into place. The track bar 34 will help to secure the items within the vehicle as well as provide support and stabilize the rear portion of the frame 46 of the adjustable enclosure. An additional track bar 34 can be slid into a lower track 35 to provide additional support to the lower portion of the frame 46 of the adjustable enclosure. The tailgate 32 can then be closed or left open depending on the wishes of the user.

The side walls or roof panels of the enclosure can be configured in many different ways. The side walls or roof panels can be solid such that when the roof panels are in the closed position, there are no windows to allow direct light into the enclosure, though some light may nonetheless enter from the windshield and/or driver and passenger seat windows. Alternatively, windows 28 can be configured into the side wall as well as roof panels. In this figure, the side panels each contain windows 28 as well as the rear roof panel 26, but the front roof panel 24 does not include a window.

It is also contemplated by the inventor that the roof panels can be stacked together but not secured on top of the roof rack, such that a smaller portion of the pickup truck is open without a roof portion.

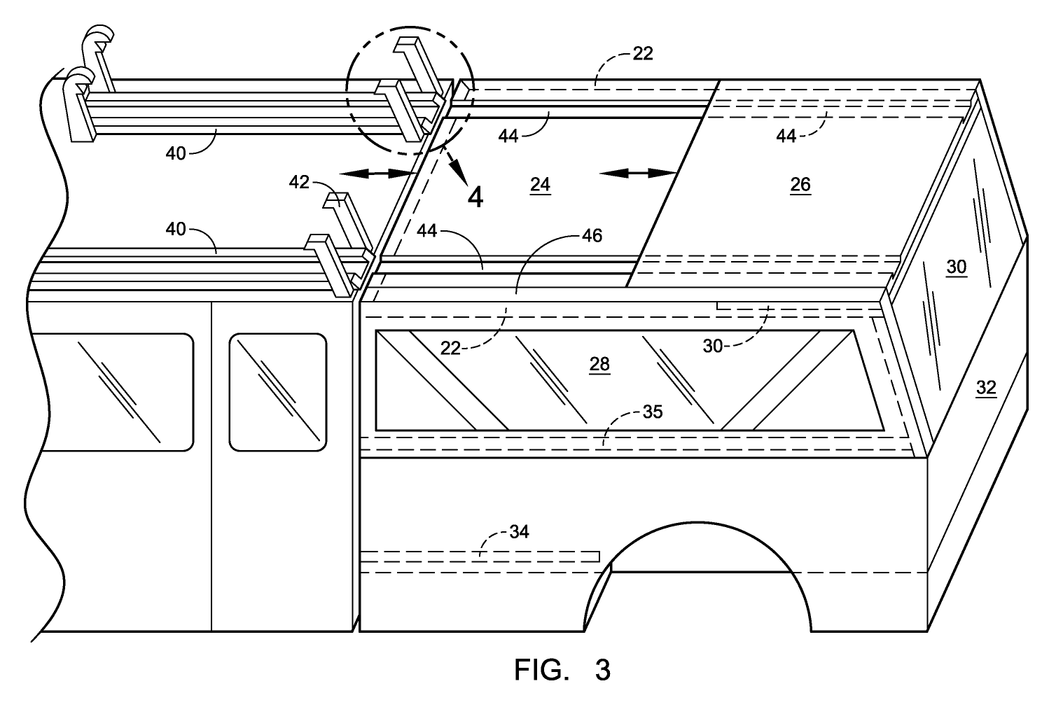

FIG. 3 is a side perspective view of an additional embodiment of the current invention attached to a pickup truck. In this embodiment, the enclosure is attached to a pickup truck with a tailgate where the enclosure is attached to the top rails of the pickup truck bed. It is an adjustable enclosure with a front roof panel 24, a rear roof panel 26, and a hatch 30.

To open up the enclosure such that the bed of the pickup truck has no roof, a user will first unlock and open the tailgate 32 of the vehicle. The user then lifts the hatch 30 parallel to the tailgate 32 and slides the hatch 33 into the rear roof panel 26. The rear roof panel 26 and the front roof panel 24 each have channels 44, which are used to align the two panels as they are pushed together. Pushing the rear roof panel 26 on top of the front roof panel 24 creates stacked panels. The stacked panels are then pushed onto a roof rack 40, where the roof rack 40 is secured to the top of the cab of the pickup truck. Once the stacked panels are located on top of the roof rack 40, roof panel clamps 42 are rotated to an upright position and locked in place using a locking pin (not shown in this figure) thereby locking the stacked roof panels in place above the cab of the pickup truck.

The front roof panel 24 and rear roof panel 26 are now secured in the open position, thereby providing an open area in the pickup truck for the storage and/or transportation of oversized items that could not otherwise have been easily transported in the enclosed area of the vehicle. After the items have been secured in the vehicle, a track bar 34 can be slid into an upper track 22, which travels along the upper portion of the enclosure, and locked into place. The track bar 34 will help to secure the items within the vehicle as well as provide support and stabilize the adjustable enclosure. An additional track bar 34 can be slid into a lower track 35 to provide additional support to the lower portion of the adjustable enclosure and/or secure the load. The tailgate 32 can then be closed or left open depending on the wishes of the user.

The side walls, hatch 30, or roof panels of the enclosure can be configured in many different ways. The side walls, hatch 30, or roof panels can be solid such that when the roof panels and hatch 30 are in the closed position, there are no windows to allow direct light into the enclosure, though some light may nonetheless enter from the windshield and/or driver and passenger seat windows. Alternatively, windows 28 can be configured into the side wall as well as the hatch 30 and/or roof panels. In this figure, the side panels each contain windows 28. The roof panels do not include windows, but the hatch is essentially a framed window that is hinged to and can slide into the rear roof panel.

It is also contemplated by the inventor that the roof panels can be stacked together but not secured on top of the roof rack, such that a smaller portion of the pickup truck is open without a roof portion.

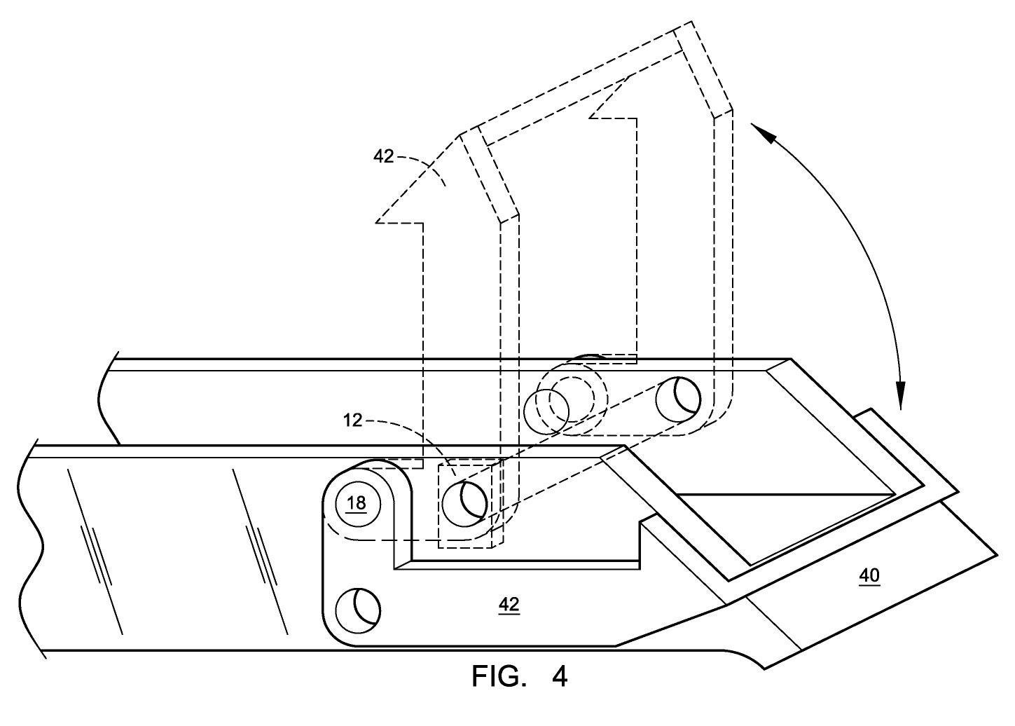

FIG. 4 is a side perspective view of a portion of the roof rack used to secure the roof panels while the roof of the adjustable enclosure is open. Roof rack 40 is used to support roof panels on the roof of a vehicle. After the roof panels have been slid onto the roof rack 40, a roof panel clamp 42 is used to secure roof panels in place. The roof panel clamp 42 pivots about pivot point 18, where the roof panel clamp 42 can pivot from a horizontal to a vertical position. In this figure, the vertical position of the roof panel clamp 42 is shown by dashed lines. The roof panel clamp 42 is secured in the vertical position by using a locking pin 12.

The embodiments of the invention have mainly been described in the action of opening the roof of the adjustable enclosure. It should be understood that the roof of the enclosure can be closed by simply following the same steps outlined above, but in reverse.

Attaching the adjustable enclosure to the rails of a truck bed can be achieved in many different ways that are well known in the art, including nuts and bolts, bolts with quick release pins, welding, and adhesives.

What I claim is:

1. An adjustable enclosure for use on a vehicle comprising:
a left sidewall, a right sidewall, and a plurality of roof panels, where the plurality of roof panels can be in a closed position and in an open position,
where the left sidewall and right sidewall support the plurality of roof panels when in the closed position,
where the plurality of roof panels cover a portion of the vehicle when in the closed position and leave a portion of the vehicle exposed when in the open position, where the plurality of roof panels can be stacked on top of each other, where the plurality of roof panels are stored in or on the vehicle when in the open position, where a user can quickly and easily change the plurality of roof panels from a closed position to an open position and from an open position to a closed position without removing any part of the adjustable enclosure from the vehicle.

2. The adjustable enclosure of claim 1, further comprising a hatch, where the hatch can be in an open position or a closed position, where the hatch is used to further enclose the space beneath the plurality of roof panels when in the closed position, and where the hatch is stored in or on the vehicle when in the open position.

3. The adjustable enclosure of claim 2, where the hatch is stored behind the driver and passenger seats of the vehicle when in the open position.

4. The adjustable enclosure of claim 2, where the hatch is stored inside of one of the plurality of roof panels when in the open position.

5. The adjustable enclosure of claim 1, where the adjustable enclosure is attached to the rails of a pickup truck bed.

6. The adjustable enclosure of claim 1, where the adjustable enclosure is integrated into a sport utility vehicle.

7. The adjustable enclosure of claim 1, where the plurality of roof panels slide along a track, where the track extends along the top portion of the adjustable enclosure and at least a portion of the vehicle's roof whereby the plurality of roof panels are stored over the roof of the vehicle when the plurality of roof panels are in the open position.

8. The adjustable enclosure of claim 7, where the plurality of roof panels are stacked and stored over the roof of the vehicle when the plurality of roof panels is in the open position.

9. The adjustable enclosure of claim 1, where each of the plurality of roof panels comprises channels, where these channels are used to align the plurality of roof panels when a user pushes them together, where the plurality of roof panels are stacked when pushed together.

10. The adjustable enclosure of claim 9, where the plurality of roof panels are stored and secured on a roof rack when the plurality of roof panels is in the open position, where the roof rack is located on the roof of the vehicle.

11. The adjustable enclosure of claim 1, where at least one of the plurality of roof panels comprises a window.

12. The adjustable enclosure of claim 1, where one or both of the sidewalls comprises a window.

13. The adjustable enclosure of claim 1, further comprising a track bar, where the left sidewall and right sidewall each comprise a track, where each end of the track bar slides into one of the tracks thereby connecting the two sidewalls together, and where the track bar can be secured to each track at a specific location along the length of the track.

14. An adjustable enclosure for use on a vehicle comprising:
a left sidewall, a right sidewall, a hatch, and a plurality of roof panels, where the plurality of roof panels can be in a closed position and in an open position,
where the left sidewall and right sidewall support the plurality of roof panels when in the closed position,
where the plurality of roof panels cover a portion of the vehicle when in the closed position and leave a portion of the vehicle exposed when in the open position, where the plurality of roof panels can be stacked on top of each other, where the plurality of roof panels are stored in or on the vehicle when in the open position, where a user can quickly and easily change the plurality of roof panels from a closed position to an open position and from an open position to a closed position without removing any part of the adjustable enclosure from the vehicle,
where the hatch can be in an open position or a closed position, where the hatch is used to further enclose the space beneath the roof panels when in the closed position, and where the hatch is stored in or on the vehicle when in the open position.

15. The adjustable enclosure of claim 14, where the hatch is stored behind the driver and passenger seats of the vehicle when in the open position.

16. The adjustable enclosure of claim 14, where the hatch is stored inside of one of the plurality of roof panels when in the open position.

17. The adjustable enclosure of claim 14, where the plurality of roof panels slide along a track, where the track extends along the top portion of the adjustable enclosure and at least a portion of the vehicle's roof whereby the plurality of roof panels are stored over the roof of the vehicle when the plurality of roof panels are in the open position, where the plurality of roof panels are stacked and stored over the roof of the vehicle when the plurality of roof panels is in the open position.

18. The adjustable enclosure of claim 14, where each of the plurality of roof panels comprises channels, where these channels are used to align the plurality of roof panels when a user pushes them together, where the plurality of roof panels are stacked when pushed together, where the plurality of roof panels are stored and secured on a roof rack when the plurality of roof panels is in the open position, where the roof rack is located on the roof of the vehicle.

19. The adjustable enclosure of claim 14, where the hatch comprises a window.

20. An adjustable enclosure for use on a vehicle comprising:
a left sidewall, a right sidewall, a hatch, and a plurality of roof panels, where the plurality of roof panels can be in a closed position and in an open position,
where the left sidewall and right sidewall support the plurality of roof panels when in the closed position,
where the plurality of roof panels cover a portion of the vehicle when in the closed position and leave a portion of the vehicle exposed when in the open position, where the plurality of roof panels can be stacked on top of each other, where the plurality of roof panels are stored in or on the vehicle when in the open position, where a user can quickly and easily change the plurality of roof panels from a closed position to an open position and from an open position to a closed position without removing any part of the adjustable enclosure from the vehicle,
where the hatch can be in an open position or a closed position, where the hatch is used to further enclose the space beneath the roof panels when in the closed position, where the hatch is stored in or on the vehicle when in the open position,
where the vehicle has a roof, and where the plurality of roof panels are stacked and stored over the roof of the vehicle when the plurality of roof panels is in the open position.
